(19) United States
(12) Patent Application Publication
(10) Pub. No.: US 2024/0351178 A1
(43) Pub. Date: Oct. 24, 2024

(54) UTILITY TOOL

(71) Applicant: Bo Lindell, Eriksdale (CA)

(72) Inventor: Bo Lindell, Eriksdale (CA)

(21) Appl. No.: 18/304,274

(22) Filed: Apr. 20, 2023

(51) Int. Cl. B25F 1/00; H02G 1/02

(52) U.S. Cl. CPC B25F 1/00; H02G 1/02

(57) ABSTRACT

A multi-purpose tool configured to be utilized by an electrical lineman or similar profession wherein the tool of the invention is capable of facilitating execution of a plurality of tasks. The invention includes a body that is elongated in shape having a first end and a second end. Formed in the second end of the body are a plurality of triangular shaped notches wherein the center notch has a greater depth. An aperture is formed in the body proximate the second end and is annular in shape. The first end of the body has a curved portion integrally formed therewith wherein the curved portion includes a first section and a second section formed in a radius creating the shape of the curved portion. The second section of the curved portion includes a pin removal aperture. A pin extractor member is contiguously formed with the second section and extends outward therefrom.

### FIELD OF THE INVENTION

The present invention relates generally to tools, more specifically but not by way of limitation, a multi-purpose utility tool designed to be utilized by lineman wherein the present invention assists in executing multiple functions commonly performed by lineman such as but not limited to separation of transmission bells, undoing of preforms, bending keys and removing keys.

### BACKGROUND

The primary job of a lineman is to install, repair, and maintain high-powered electrical lines and systems. Lineman work on transmission and distribution lines from the power sources and extend to individual buildings or homes. Electrical lineman set up and maintain power lines that keep electricity flowing to homes and businesses. They also act as first responders when natural disasters cause power outages. Lineman typically work for utility companies or direct contractors thereof. Typical duties for a linemen can include but are not limited to the following: install, maintain or repair power lines, identify defective devices, voltage regulators, transformers and switches, inspect and test power lines, string power lines between poles, towers and buildings and operate power equipment when installing and repairing poles, towers and lines.

While performing the aforementioned tasks, the lineman will often employ the utilization of a plurality of different tools. Commonly utilized tools include but are not limited to pliers and screwdrivers. While these tools and others are capable of assisting a lineman perform required tasks, the challenge of utilizing multiple tools can be difficult in certain environments. As the tools utilized by lineman are generic, they can lead to issues such as but not limited to breakage of transmission bells.

Accordingly, there is a need for a specialized tool that can be utilized by lineman wherein the tool is configured to facilitate execution of a plurality of tasks commonly performed by lineman.

### SUMMARY OF THE INVENTION

It is the object of the present invention to provide a multi-purpose tool configured to assist a lineman in performing a plurality of tasks wherein the present invention includes a body that is elongated having first end and a second end.

Another object of the present invention is to provide a tool that is operable to execute a plurality of functions commonly performed by a lineman wherein the second end of the body includes an aperture for engaging a hot stick.

A further object of the present invention is to provide a multi-purpose tool configured to assist a lineman in performing a plurality of tasks wherein the second end of the body includes three triangular shaped notches formed therein.

Yet a further object of the present invention is to provide a tool that is operable to execute a plurality of functions commonly performed by a lineman wherein the first end includes a curved portion.

Still another object of the present invention is to provide a multi-purpose tool configured to assist a lineman in performing a plurality of tasks wherein the curved portion includes an aperture formed in a section thereof.

An additional object of the present invention is to provide a tool that is operable to execute a plurality of functions commonly performed by a lineman wherein a pin extractor member is contiguously formed with the curved portion of the second end of the body.

Yet a further object of the present invention is to provide a multi-purpose tool configured to assist a lineman in performing a plurality of tasks wherein the middle of the body includes a non-conducting handle member surroundably mounted thereto.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a side view of an embodiment of the present invention; and

FIG. 2 is rear view of the present invention; and

FIG. 3 is a front perspective view of the present invention.

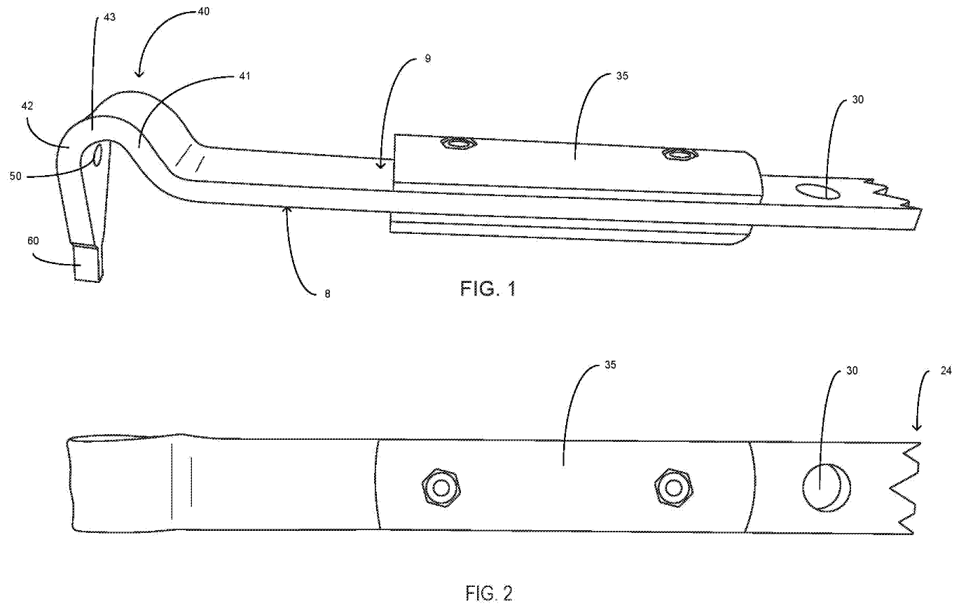

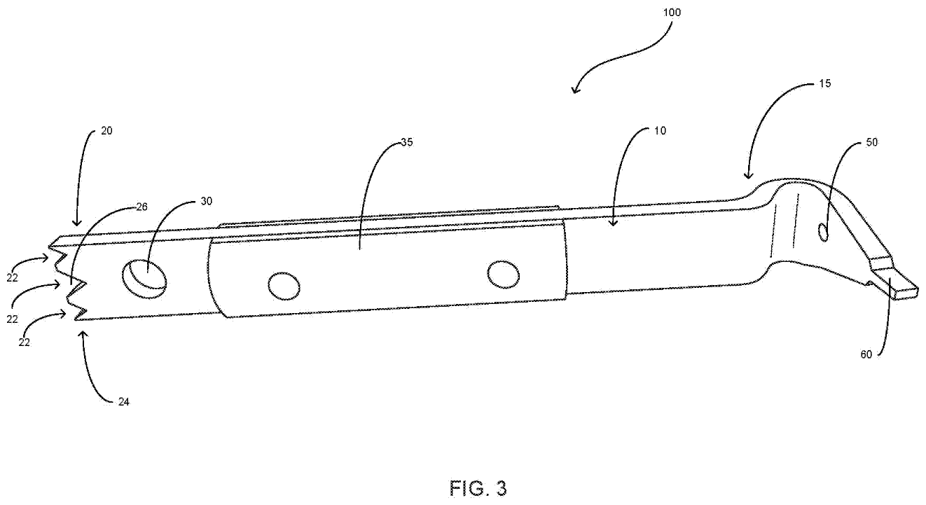

### DETAILED DESCRIPTION

Referring now to the drawings submitted herewith, wherein various elements depicted therein are not necessarily drawn to scale and wherein through the views and figures like elements are referenced with identical reference numerals, there is illustrated a multi-purpose tool 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the multi-purpose tool 100 includes a body 10 wherein the body 10 is elongated in manner having a first end 15 and a second end 20. The body 10 is manufactured from a durable rigid material such as but not limited to metal flat bar. It should be understood within the scope of the present invention that the body 10 could be provided in alternate lengths. The body 10 includes a second end 20 wherein the second end 20 has formed thereon a plurality of notches 22. The notches 22 formed a lower edge 24 that is jagged in shape. The shape of the lower edge 24 is operable to engage an open end of a retaining key. A center notch 26 is provided that is formed at a height greater that the notches 22 to either side thereof. The center notch 26 is formed at a greater height so as to be utilized to engaged a closed side of a retaining key and move to insert back into an aperture or receiving slot. While three notches 22 are illustrated herein for the preferred embodiment of the multi-purpose tool 100, it is contemplated within the scope of the present invention that the multi-purpose tool 100 could be provided with less than or more than three notches 22.

An aperture 30 is formed in the body 10 proximate the second end 20. The aperture 30 is annular in shape and is operable to be utilized to engage a hot stick which is an insulated tool having an end that can be operably engaged with aperture 30. It should be understood within the scope of the present invention that the aperture 30 could be provided in alternate shapes and sizes in order to achieve the desired objective. A handle member 35 is mounted to the body 10 and present on both sides thereof. The handle member 35 is manufactured from a durable non-conductive material such as but not limited wood. It is contemplated within the scope of the present invention that the handle member 35 could be provided in alternate sizes and shapes.

First end 15 has contiguously formed therewith a curved portion 40. Curved portion 40 includes first section 41 wherein first section 41 extends outward beyond second side 9 of the body 10. A second section 42 of the curved portion 40 is contiguous with the first section 41 and is directed back towards the body 10 and beyond the first side 8 thereof. The curved portion 40 provides leverage when employing use of the aperture 50 and/or pin extractor member 60. It should be understood within the scope of the present invention that the curved portion 40 could be provided in alternate radiuses. Furthermore, it is contemplated within the scope of the present invention that the height that the first section 41 extends beyond the second side 9 could vary. Additionally, it should be understood within the scope of the present invention that the second section 42 could extend beyond the first side 8 of the body 10 in alternate lengths.

The second section 42 of the curved portion 40 includes a pin engagement aperture 50. The pin engagement aperture 50 is annular in shape and is configured to receive therein a leg of a cotter pin wherein subsequent engagement thereof the apex 43 is leveraged against a support surface and force is applied to the body 10 so as to bend the leg of the cotter pin to secure into the desired location. The pin engagement aperture 50 is smaller in diameter than the aperture 30 present at the second end 20 of the body 10.

Contiguously formed with the second section 42 of the curved portion 40 is the pin extractor member 60. The pin extractor member 60 is rectangular and flat in shape having a thickness that will facilitate an ability to be journaled into a looped end of a conventional cotter pin so as to facilitate removal thereof. The pin extractor member 60 is manufactured of sufficient length so as to be inserted into the looped end of a conventional cotter pin. The second section 42 is tapered in width wherein the width thereof proximate the pin extractor member 60 is narrower so as to inhibit interference with operable coupling with a cotter pin during the removal process.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A multi-purpose tool configured to perform a plurality of tasks wherein the multi-purpose tool comprises:
a body, said body being elongated in shape, said body having a first end and a second end, said body having a first side and a second side, said body having an aperture proximate said second end, said aperture being annular in shape, said body having a curved portion proximate said first end, said curved portion having a first section and a second section, said first section and said second section being contiguous and formed in an arcuate shape, said first section extending beyond said second side of said body, said second section of said curved portion extending towards said body and beyond said first side, said second section of said body being tapered in shape.

2. The multi-purpose tool as recited in claim 1, wherein said second end includes three notches formed therein, wherein said three notches are triangular in shape.

3. The multi-purpose tool as recited in claim 2, wherein said three notches includes a center notch, said center notch having a height greater than two laterally adjacent notches.

4. The multi-purpose tool as recited in claim 3, and further including a pin removal aperture, said pin removal aperture being formed in said second section of said curved portion, said pin removal aperture having a diameter that is less than a diameter of said aperture proximate said second end.

5. The multi-purpose tool as recited in claim 4, wherein said second section of said curved portion is tapered in width.

6. The multi-purpose tool as recited in claim 5, and further including a pin extractor member, said pin extractor member being contiguously formed with said second section of said curved portion, said pin extractor member being rectangular in shape and flat in form.

7. The multi-purpose tool as recited in claim 6, and further including a handle member, said handle member being surroundably mounted to a portion of said body, said handle member being manufactured from a non-conductive material.
